(19) United States
(12) Patent Application Publication
(10) Pub. No.: US 2024/0038085 A1
(43) Pub. Date: Feb. 1, 2024

(54) INTERACTIVE GAME SYSTEM AND VIRTUAL WORLD FOR EDUCATING USERS ABOUT CRYPTOCURRENCY

(71) Applicant: Truist Bank, Charlotte, NC (US)

(72) Inventors: Oneka Williams, Atlanta, GA (US); Chuong Dinh, Atlanta, GA (US); Gregory Phillips, Atlanta, GA (US)

(73) Assignee: Truist Bank, Charlotte, NC (US)

(21) Appl. No.: 17/876,651

(22) Filed: Jul. 29, 2022

(51) Int. Cl. G09B 5/06; G09B 19/18; G06T 19/00; G06T 13/40

(52) U.S. Cl. CPC G09B 5/06; G09B 19/18; G06T 19/003; G06T 13/40

(57) ABSTRACT

Some examples described herein involve an interactive game system and virtual world for educating users about cryptocurrency. In one example, a system can generate a three-dimensional (3D) virtual world for a video game. The 3D virtual world can include game objects and a virtual avatar representing a user, where the virtual avatar is movable within the 3D virtual world to interact with the game objects. The system can detect an interaction between the virtual avatar and one of the game objects within the 3D virtual world and, in response to detecting the interaction, select a learning module. The system can select the learning module from among a group of learning modules based on the game object. The learning module can be configured to provide an educational tutorial to teach the user about cryptocurrency. The system can then execute the learning module to provide the educational tutorial to the user.

### TECHNICAL FIELD

The present disclosure relates generally to computerized gaming systems. More specifically, but not by way of limitation, this disclosure relates to an interactive game system and virtual world for helping to educate users about the topic of cryptocurrency.

### BACKGROUND

Cryptocurrencies have recently grown in popularity. Many cryptocurrencies, such as Bitcoin and Ethereum, are digital currencies in which transactions are verified and records maintained by a decentralized system using cryptography, rather than by a centralized authority. Those records may be maintained on a blockchain or another type of distributed database system. Although cryptocurrencies have recently grown in popularity, they are still a relatively new technology and many individuals lack a basic understanding of what they are and how they function. The way in which various cryptocurrencies function can also be technically complex, making them challenging to understand for the average individual. Although some basic educational tools exist, like blog posts and websites, many of these tools present information in a static way that is not interesting or engaging for the average user.

### SUMMARY

One example of the present disclosure includes a method involving generating a three-dimensional (3D) virtual world for a video game, the 3D virtual world including game objects and a virtual avatar representing a user, the virtual avatar being movable by the user within the 3D virtual world to interact with the game objects; detecting an interaction between the virtual avatar and a game object within the 3D virtual world; and in response to detecting the interaction: selecting a learning module from among a plurality of learning modules based on the game object, the learning module being configured to provide an educational tutorial to teach the user about cryptocurrency; and executing the learning module to provide the educational tutorial to the user. Some or all of these operations can be implemented by one or more processors.

Another example of the present disclosure involves a non-transitory computer-readable medium comprising program code that is executable by a processor for causing the processor to: generate a three-dimensional (3D) virtual world for a video game, the 3D virtual world including game objects and a virtual avatar representing a user, the virtual avatar being movable by the user within the 3D virtual world to interact with the game objects; detect an interaction between the virtual avatar and a game object within the 3D virtual world; and in response to detecting the interaction: select a learning module from among a plurality of learning modules based on the game object, the learning module being configured to provide an educational tutorial to teach the user about cryptocurrency; and execute the learning module to provide the educational tutorial to the user.

Yet another example of the present disclosure involves a system comprising: a processor and a memory including instructions that are executable by the processor for causing the processor to: generate a three-dimensional (3D) virtual world for a video game, the 3D virtual world including game objects and a virtual avatar representing a user, the virtual avatar being movable by the user within the 3D virtual world to interact with the game objects; detect an interaction between the virtual avatar and a game object within the 3D virtual world; and in response to detecting the interaction: select a learning module from among a plurality of learning modules based on the game object, the learning module being configured to provide an educational tutorial to teach the user about cryptocurrency; and execute the learning module to provide the educational tutorial to the user.

### BRIEF DESCRIPTION OF THE DRAWINGS

FIG. 1 shows a block diagram of an example of a system for providing a virtual educational experience according to some aspects of the present disclosure.

FIG. 2 shows an example of virtual world with a selected graphical object for displaying educational content according to some aspects of the present disclosure.

FIG. 3 shows an example of virtual world with a selected graphical object for displaying educational content according to some aspects of the present disclosure.

FIG. 4 shows an example of virtual world with a selected graphical object for engaging in a cryptocurrency purchase according to some aspects of the present disclosure.

FIG. 5 shows an example of virtual world with a selected graphical object for engaging in a cryptocurrency transaction according to some aspects of the present disclosure.

FIG. 6 shows a flow chart of an example of a process for implementing some aspects of the present disclosure.

FIG. 7 shows a block diagram of a computing device usable for implementing some aspects of the present disclosure.

### DETAILED DESCRIPTION

Certain aspects and features of the present disclosure relate to an interactive game system and virtual world designed to help educate users about the topic of cryptocurrency. For example, the game system can generate a three-dimensional (3D) virtual world that includes various types of game objects, such as virtual buildings, cars, roads, trees, vehicles, animals, etc. The virtual world can include a virtual avatar representing a user, where the user can control the virtual avatar to move it around the virtual world and interact with the game objects. In response to interactions between the user's virtual avatar and the game objects, the game system can select and execute learning modules. Each of the learning modules may be designed to provide an educational experience related to a particular cryptocurrency topic to the user. Some learning modules may provide videos and tutorials, while other learning modules may provide interactive simulated experiences. For example, some learning modules may be designed to explain how a particular cryptocurrency works, while other learning modules may be designed to simulate purchasing cryptocurrencies from an exchange or engaging in cryptocurrency transactions with other users. As the user continues through the video game (e.g., by advancing through game levels or obtaining higher scores), the user may unlock learning modules that are more advanced. Through this interactivity and guided learning, a user may develop a deeper understanding about the topic of cryptocurrency in a fun and engaging way.

In some examples, the user can earn points for completing learning modules. The user can then exchange the points for game objects (e.g., virtual weapons, vehicles, supplies, or tools) that may make the game more enjoyable to play. For example, the video game may include a virtual marketplace through which the user can exchange points for virtual goods.

In some examples, the user can exchange points (e.g., virtual currency) to access services offered outside of the video game by a service provider. In other examples, the user may automatically unlock access to such services by completing a certain number of learning modules, or achieving a certain game level or score. The service provider may be the same as or different from the entity that is hosting the video game.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

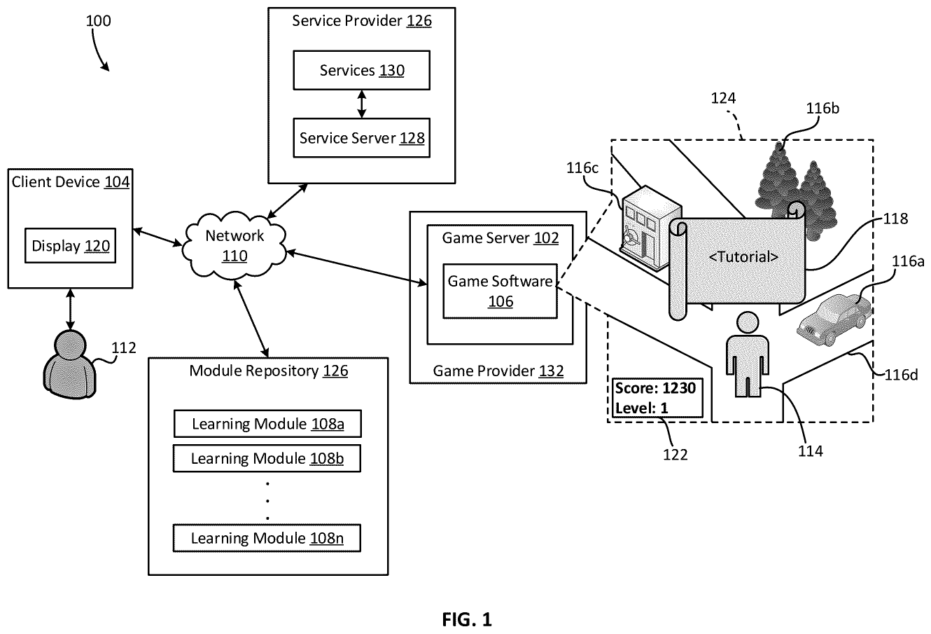

FIG. 1 shows a block diagram of an example of a system 100 for providing a virtual educational experience according to some aspects of the present disclosure. The system 100 includes a game server 102 executing game software 106 to generate a three-dimensional (3D) game environment 124, such as a virtual world. The game server 102 may include one server or multiple servers. The 3D game environment 124 can be accessed by a user 112 via a client device 104, such as a laptop computer, desktop computer, mobile phone, or tablet. The client device 104 can connect to the game server 102 via one or more networks, such as the Internet, to allow the user 112 to play the video game.

The 3D game environment 124 can include a virtual avatar 114 representing the user 112 during gameplay. The 3D game environment 124 can also include other game objects, such as game objects 116a-d. A game object is a virtual object that is present within the 3D game environment 124. Examples of game objects can include pathways such as streets or roads; vehicles such as cars, airplanes, boats, and trucks; buildings such as banks, houses, and shops; tools such as knives, hammers, saws, and screwdrivers; animals such as house pets and livestock; plants such as trees, flowers, and grass; furniture such as couches, tables, and chairs; jewelry, such as earrings and bracelets; and clothing such as shirts, pants, and shoes. Game objects may also include other virtual avatars that represent other real users or simulated users within the video game. For example, if the video game is a multiplayer game that can be played concurrently by multiple users, the 3D game environment 124 may be a virtual world that includes multiple virtual avatars corresponding to the multiple concurrent players of the video game.

The user 112 can use the client device 104 to control the virtual avatar 114. For example, the user 112 can operate the client device 104 to move the virtual avatar 114 around in the 3D game environment 124 and to cause the virtual avatar 114 to engage in various interactions with the game objects. Examples of such interactions can include opening, closing, touching, moving, picking up, setting down, turning, breaking, slicing, or shooting a game object. In some examples, the virtual avatar 114 can engage in multiple different types of interactions with a single game object. For example, the user 112 can cause the virtual avatar 114 to pick up a game object, move it to a new location within the 3D game environment 124, and then set it down. Some types of interactions may only become available to the user 112 once the user 112 has reached a certain game level or score 122. For example, the user 112 may need to reach a certain game level in order to unlock a certain type of interaction with a particular virtual object, such as the ability to enter a particular virtual building in the 3D game environment 124.

Some game objects can be associated with learning modules 108a-n. The learning modules 108a-n can be configured to provide educational tutorials 118 relating to cryptocurrency or another topic. The educational tutorials 118 can include videos, animations, audio, text, simulations, or any combination of these. Some of the learning modules 108a-n may be designed for more advanced users and may only be provided after the less-advanced learning modules are completed. And some learning modules 108a-n may only become accessible to the user 112 once a certain criterion has been met. For example, the game server 102 may prevent the user 112 from accessing learning module 108n until the user 102 has achieved a certain game level or score 122, or until the user 102 has completed one or more prerequisite learning modules. This may help ensure that the user 112 has completed the required foundational learning to understand the more advanced topics discussed in learning module 108n.

As alluded to above, the game server 102 can detect interactions between the user's virtual avatar 114 and game objects in the 3D game environment 124. In response to detecting an interaction with a game object, the game server 102 can select an appropriate learning module from among a group of candidate learning modules 108a-n and execute that learning module to provide the corresponding educational tutorial 118 to the user 112. The learning modules 108a-n may be stored in a module repository 126, which may be accessible to the game server 102 via the one or more networks 110. The learning modules 108a-n may be developed by the entity hosting the game server 102, third parties, or both.

Any number of game objects can be associated with any number of learning modules 108a-n. For example, a single game object may be associated with multiple learning modules 108a-b. In some such examples, the game server 102 may initially provide a first learning module 108a to the user 112 in response to an interaction with that game object 116a. The game server 102 may provide the first learning module 108a to the user 112, each time the user's virtual avatar 114 interacts with the game object 116a, until the user completes that learning module 108a. After the user 112 completes the first learning module 108a, the game server 102 may provide a second learning module 108b to the user 112 in response to subsequent interactions with that same game object 116a. In this way, the user 112 may be prevented from accessing the second learning module 108a until after the user 112 completes the first learning module 108a. In some examples, the order in which learning modules 118a-n are presented to the user 112 in the video game may be at least partially predesignated by a game developer or another entity, so as to provide a guided learning experience.

If the user's virtual avatar 114 interacts with a game object, the game server 102 can determine which learning module 108a to provide to the user 112 based on one or more factors. Examples of such factors include a characteristic of the game object (e.g., its type or location), a characteristic of the interaction (e.g., its type, duration, or location), the user's score, the user's game level, historical information about tutorials previously viewed or completed by the user 112, or any combination of these. Different types of interactions with the same game object may lead to the presentation of different learning modules. Interactions with different game objects may also lead to the presentation of different learning modules. Whether the user has already previously viewed or completed one or more learning modules may also affect which learning module selected, for example so that the same learning module is not provided again after if it has already been completed, or so that more advanced learning modules are not provided before simpler ones. In some examples, the game server 102 can keep track of which learning modules 108a-n have been viewed and completed by the user 120 in a database. The game server 102 can access and use this historical tutorial data to determine which learning module to provide to the user 112 in response to a given interaction with a game object.

As the user 112 plays the video game, the user 112 can progress through game levels and gain points. In some examples, the user 112 can exchange the points to access services 130 offered inside or outside of the video game by a service provider 126. The service provider 126 may be the same as or different from the entity that is hosting the video game (e.g., the game provider 132 operating the game server 102). For example, the user 112 can access a virtual market within the 3D game environment 124 and trade points to access a service 130 offered by the service provider 126 outside of the video game. An example of such a service 130 can include a certain type of financial account or credit line, for example if the service provider 126 is a bank. The game server 102 can detect this exchange and responsively interact with a service server 128, via the one or more networks 128, to unlock access to the service 130 for the user 112. The service server 128 can be a server operated by the service provider 126. In some examples, the game server 102 may interact with the service server 128 to automatically unlock access to one or more services 130 for the user 112 in response to certain game events. Examples of such events can include the user 112 achieving a particular game level or score, the user 112 completing a certain learning module or series of learning modules, or the user 112 interacting with a particular game object.

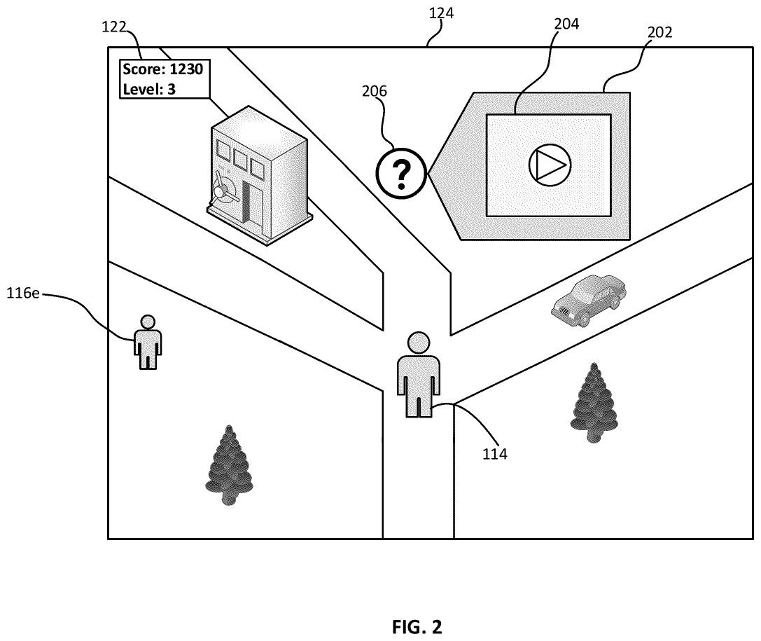

In some examples, the game server 102 can prevent certain game objects from being included in the 3D game environment 124 until the user 112 reaches a certain game level or score 122. Upon the user achieving to that game level or score, the new game object may become available. One example of this is shown in FIG. 2. In this example, the user 112 has advanced to Level 3, at which point the game server 102 can update the 3D game environment 124 to remove one or more existing game objects (e.g., the virtual trees) and to include one or more new game objects (e.g., game object 206). The user 112 may then control the virtual avatar 114 to interact with a new game object 206. The game server 102 can detect the interaction, select an appropriate learning module based on the interaction with the new game object 206, and execute the learning module. In some examples, the game server 102 can provide the learning module within a graphical overlay 202 that visually overlays at least a portion of the game screen. The graphical overlay 202 can include the tutorial content 204, which in this example is a video.

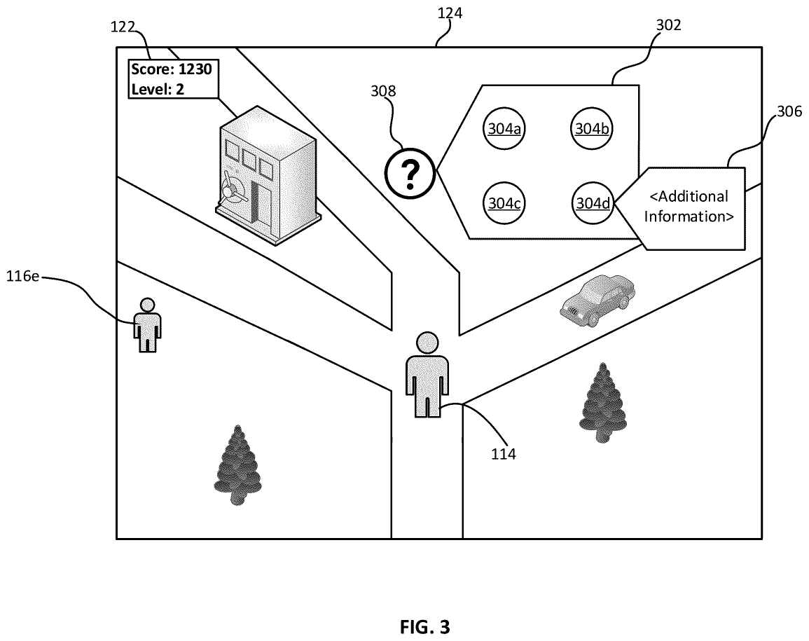

In some examples, a learning module can include multiple graphical objects, each of which may be selectable to access additional information (e.g., related to the topic of cryptocurrency). One example of this is shown in FIG. 3. As shown, the user 112 can control the virtual avatar 114 to interact with a game object 308. The game server 102 can detect the interaction, select an appropriate learning module based on the interaction with the game object 206, and execute the learning module. In this example, the learning module can include additional graphical objects 304a-d, such as buttons, sliders, drop-downs, checkboxes, text, icons, and images. Each of the graphical objects 304a-d may be selectable to launch additional learning content, which may be presented in an additional window or overlay 306.

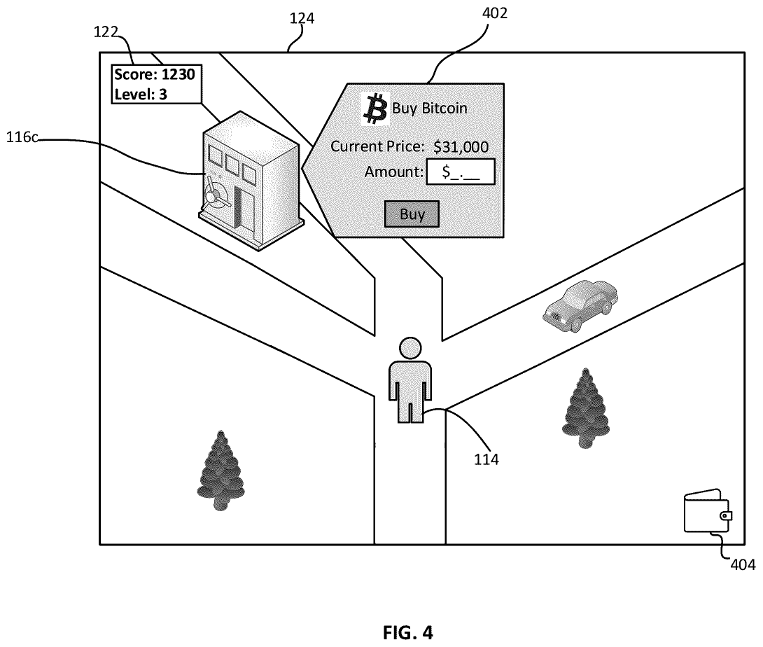

In some examples, a learning module can be configured to simulate purchasing a cryptocurrency from an exchange. One example of this is shown in FIG. 4. As shown, a user 112 can control their virtual avatar 114 to interact with a game object 116c. The game server 102 can detect the interaction, select an appropriate learning module based on the interaction with the game object 206, and execute the learning module. In this example, the learning module includes a form through which the user 112 can enter an amount of a cryptocurrency (e.g., Bitcoin) to buy from an exchange in a simulated transaction. The learning module can also include a current value for the cryptocurrency and other information about the cryptocurrency or the exchange. The user 112 can enter the purchase amount and select a button to initiate the simulated purchase. The game server 102 can detect the button's selection and responsively initiate a simulated purchase process by which a simulated amount of the cryptocurrency is transferred into the user's digital wallet 404, which may be a simulated digital wallet that is part of the video game. These simulations can allow the user 112 to practice working with cryptocurrencies without using real money. In some examples, the user 112 can select the digital wallet 404 to view their cryptocurrency balances in the video game at any given point in time, along with other related information such as a transaction history, net gains or losses, etc.

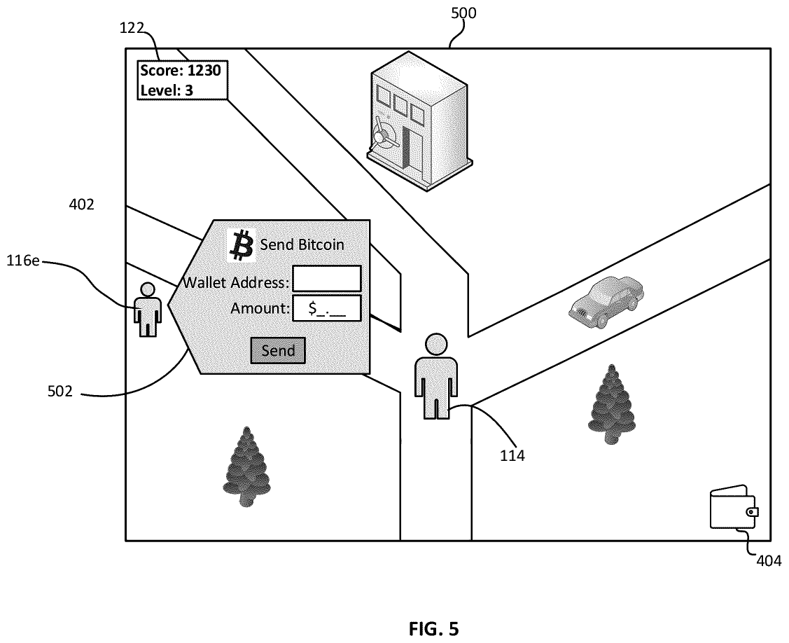

In some examples, a learning module can be configured to simulate transmitting cryptocurrency to another user. One example of this is shown in FIG. 5. As shown, a user 112 can control their virtual avatar 114 to interact with a game object 116e, which in this example is an avatar for another user. The game server 102 can detect the interaction, select an appropriate learning module based on the interaction with the game object 206, and execute the learning module. In this example, the learning module includes a form through which the user 112 can enter an amount of a cryptocurrency to transmit to the other user in a simulated transaction. The learning module can also include form input through which the user 112 can enter other information, such as the other user's wallet address, to facilitate the simulated cryptocurrency transaction. The user 112 can enter the transaction details and select a button to initiate the simulated transfer. The game server 102 can detect the button's selection and responsively initiate a simulated transfer process by which a simulated amount of the cryptocurrency is transferred into the other user's digital wallet, which may also be a simulated digital wallet that is part of the video game. The user's digital wallet 404 can then be updated to reflect a current cryptocurrency balance subsequent to the simulated transaction.

It will be appreciated that the examples shown in FIGS. 1-5 are intended to be illustrative and non-limiting. Other examples may include more components, fewer components, different components, or a different arrangement of the components than is shown in FIGS. 1-5. For instance, the 3D game environment 124 may involve other types of game objects and learning modules than those shown in FIGS. 1-5.

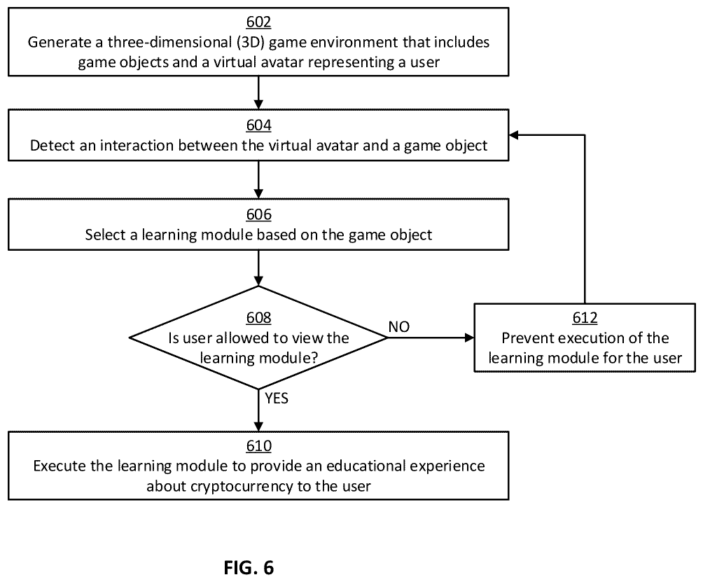

FIG. 6 shows a flow chart of an example of a process for implementing some aspects of the present disclosure. Other examples may involve more steps, fewer steps, different steps, or a different order of the steps than is shown in FIG. 6. The steps of FIG. 6 will now be described below with reference to the components of FIG. 1 described above.

In block 602, a game server 102 generates a three-dimensional (3D) game environment 124, such as a virtual world. The 3D game environment 124 can include game objects 116a-d and a virtual avatar 114 representing a user 112. The game server 102 may execute a rendering engine or another type of game engine to generate the 3D game environment 124. For example, the game server 102 may execute the Unreal Engine® by Epic Games® to generate the 3D game environment 124.

In block 604, the game server 102 detects an interaction between the virtual avatar 114 and a game object 116a. The game server 102 may detect such an interaction based on a change in a memory value, which can be associated with the virtual avatar 114 or the game object 116a. The interaction may be of any suitable type, such as a contact, bounce, tap, or selection of the game object 116a. The user 112 may control the virtual avatar 114 using a client device 104, for example to cause the virtual avatar 114 to engage in the interaction.

In block 606, the game server 102 selects a learning module 108a from among the group of candidate learning modules 108a-n based on the game object 116a. In some examples, the game server 102 can select the learning module 108a based on the game object and at least one other factor, such as a characteristic of the interaction, a game level, or a game score. For example, the game server 102 may access a predefined mapping of game objects 116a-d to learning modules 108a-n, to determine which learning module to apply in relation to the game object 116a. If the game object 116a corresponds, in the predefined mapping, to multiple learning modules 108a-b, the game server 102 may filter through the multiple learning modules 108a-b based on the one or more other factors to identify the appropriate learning module to execute. For example, the learning modules 108a-b may each be associated with certain game levels, scores, types of interactions, or other criteria that must be satisfied in order for the learning module to be executed. The game server 102 can use this criteria to select among the multiple learning modules 108a-b associated with a given game object 116a.

In block 608, the game server 102 determines whether the user 112 is allowed to view the learning module 118a selected in block 606. For example, the user 112 may be prevented from viewing the learning module 118a if the user 112 has not achieved a particular game level or score, or if they have not already completed the prerequisite learning modules. If the user 112 is not yet allowed to view the learning module 118a, the process can proceed to block 612 in which the game server 102 prevents the execution of the learning module 108a for the user 112. Otherwise, the process can proceed to block 610.

In block 610, the game server 102 executes the learning module 118a to provide an educational experience (e.g., about cryptocurrency or another topic) to the user 112. For example, the game server 102 may display a video, a text article, an animation, a simulation, or any combination of these as part of the learning module 118a.

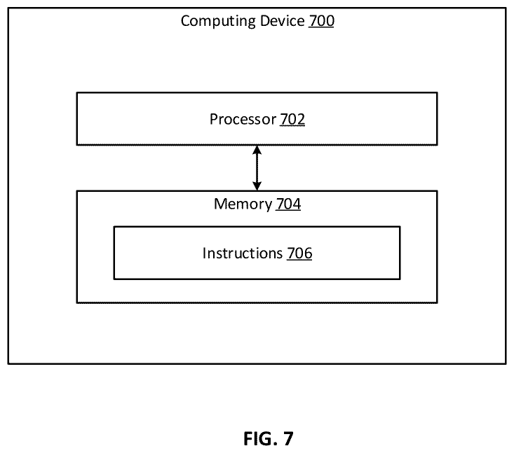

FIG. 7 shows a block diagram of a computing device 700 usable for implementing some aspects of the present disclosure. For example, the computing device 700 can serve as the game server 102 and/or the client device 104 of FIG. 1.

The computing device 700 includes a processor 702 coupled to a memory 704 via a bus. The processor 702 can include one processing device or multiple processing devices. Non-limiting examples of the processor 702 include a Field-Programmable Gate Array (FPGA), an application-specific integrated circuit (ASIC), a microprocessor, or any combination of these. The processor 702 can execute instructions 706 stored in the memory 704 to perform operations. Examples of such operations can include any of the operations described above with respect to the client device 104 or the game server 102. In some examples, the instructions 706 can include processor-specific instructions generated by a compiler or an interpreter from code written in any suitable computer-programming language, such as C, C++, C #, Python, or Java.

The memory 704 can include one memory device or multiple memory devices. The memory 704 can be non-volatile and may include any type of memory device that retains stored information when powered off. Non-limiting examples of the memory 704 include electrically erasable and programmable read-only memory (EEPROM), flash memory, or any other type of non-volatile memory. At least some of the memory device can include a non-transitory computer-readable medium from which the processor 702 can read instructions 706. A computer-readable medium can include electronic, optical, magnetic, or other storage devices capable of providing the processor 702 with computer-readable instructions or other program code. Non-limiting examples of a computer-readable medium include magnetic disks, memory chips, ROM, random-access memory (RAM), an ASIC, a configured processor, optical storage, or any other medium from which a computer processor can read the instructions 706.

The computing device 700 may also include other input and output (I/O) components, which are not shown here for simplicity. The input components can include a mouse, a keyboard, a trackball, a touch pad, a touch-screen display, or any combination of these. The output components can include a visual display, an audio display, a haptic display, or any combination of these. Examples of a visual display can include a liquid crystal display (LCD), a light-emitting diode (LED) display, and a touch-screen display. An example of an audio display can include speakers. Examples of a haptic display may include a piezoelectric device or an eccentric rotating mass (ERM) device.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A method comprising:
generating, by a processor, a three-dimensional (3D) virtual world for a video game, the 3D virtual world including game objects and a virtual avatar representing a user, the virtual avatar being movable by the user within the 3D virtual world to interact with the game objects;
detecting, by the processor, an interaction between the virtual avatar and a game object within the 3D virtual world; and
in response to detecting the interaction:
selecting, by the processor, a learning module from among a plurality of learning modules based on the game object, the learning module being configured to provide an educational tutorial to teach the user about cryptocurrency; and
executing, by the processor, the learning module to provide the educational tutorial to the user.

2. The method of claim 1, wherein the educational tutorial includes a video tutorial describing at least one cryptocurrency topic to the user.

3. The method of claim 1, wherein the educational tutorial includes an audio tutorial describing at least one cryptocurrency topic to the user.

4. The method of claim 1, wherein the learning module is configured to output a graphical overlay that includes graphical objects, the graphical overlay being configured to visually overlay at least part of a game screen output to the user, the graphical objects each being selectable by the user to provide the user with additional information about a respective cryptocurrency topic.

5. The method of claim 1, wherein each of the game objects is associated with a respective learning module of the plurality of learning modules, each learning module of the plurality of learning modules being executable to provide the user with an educational experience that is different from the other learning modules of the plurality of learning modules.

6. The method of claim 1, wherein the learning module is only accessible to the user subsequent to the user achieving at least a particular score or game level in the video game.

7. The method of claim 1, wherein the game object is only accessible to the user subsequent to the user achieving at least a particular score or game level in the video game.

8. The method of claim 1, wherein the learning module is configured to allow the user to engage in a simulated cryptocurrency transaction.

9. The method of claim 1, further comprising selecting the learning module from among the plurality of learning modules based on a characteristic of the interaction.

10. The method of claim 1, further comprising selecting the learning module from among the plurality of learning modules based on a game level associated with the user, a game score associated with the user, or historical data about tutorials previously viewed by the user.

11. A non-transitory computer-readable medium comprising program code that is executable by a processor for causing the processor to:
generate a three-dimensional (3D) virtual world for a video game, the 3D virtual world including game objects and a virtual avatar representing a user, the virtual avatar being movable by the user within the 3D virtual world to interact with the game objects;
detect an interaction between the virtual avatar and a game object within the 3D virtual world; and
in response to detecting the interaction:
select a learning module from among a plurality of learning modules based on the game object, the learning module being configured to provide an educational tutorial to teach the user about cryptocurrency; and
execute the learning module to provide the educational tutorial to the user.

12. The non-transitory computer-readable medium of claim 11, wherein the educational tutorial includes a textual tutorial describing at least one cryptocurrency topic to the user.

13. The non-transitory computer-readable medium of claim 11, wherein the educational tutorial includes an animated tutorial describing at least one cryptocurrency topic to the user.

14. The non-transitory computer-readable medium of claim 11, wherein the learning module is configured to output a graphical overlay that includes graphical objects, the graphical overlay being configured to visually overlay at least part of a game screen output to the user, the graphical objects each being selectable by the user to provide the user with additional information about a respective cryptocurrency topic.

15. The non-transitory computer-readable medium of claim 11, wherein each of the game objects is associated with a respective learning module of the plurality of learning modules, each learning module of the plurality of learning modules being executable to provide the user with an educational experience that is different from the other learning modules of the plurality of learning modules.

16. The non-transitory computer-readable medium of claim 11, wherein the learning module is only accessible to the user subsequent to the user completing at least one other learning module of the plurality of learning modules.

17. The non-transitory computer-readable medium of claim 11, wherein the learning module is configured to allow the user to engage in a simulated cryptocurrency transaction.

18. The non-transitory computer-readable medium of claim 11, further comprising program code that is executable by the processor for causing the processor to select the learning module from among the plurality of learning modules based on a characteristic of the interaction.

19. The non-transitory computer-readable medium of claim 18, further comprising program code that is executable by the processor for causing the processor to select the learning module from among the plurality of learning modules based on a game level associated with the user, a game score associated with the user, or historical data about tutorials previously viewed by the user.

20. A system comprising:
a processor; and
a memory including instructions that are executable by the processor for causing the processor to:
generate a three-dimensional (3D) virtual world for a video game, the 3D virtual world including game objects and a virtual avatar representing a user, the virtual avatar being movable by the user within the 3D virtual world to interact with the game objects;
detect an interaction between the virtual avatar and a game object within the 3D virtual world; and
in response to detecting the interaction:
select a learning module from among a plurality of learning modules based on the game object, the learning module being configured to provide an educational tutorial to teach the user about cryptocurrency; and
execute the learning module to provide the educational tutorial to the user.
